(19) United States
(12) Patent Application Publication
(10) Pub. No.: US 2025/0103872 A1
(43) Pub. Date: Mar. 27, 2025

(54) OPTICALLY ACTIVATED NEURAL NETWORKS

(71) Applicant: HEWLETT PACKARD ENTERPRISE DEVELOPMENT LP, Spring, TX (US)

(72) Inventors: DAVID STRENSKI, Ypsilanti, MI (US); SREENIVAS RANGAN SUKUMAR, Seattle, WA (US)

(21) Appl. No.: 18/472,649

(22) Filed: Sep. 22, 2023

(51) Int. Cl. G06N 3/067

(52) U.S. Cl. CPC G06N 3/067

(57) ABSTRACT

Systems and methods are provided for an optical transport implementation of an inference engine capable of performing inferences in the optical domain. Examples include an optical device that includes photon directing devices disposed along an optical axis, each photon directing device corresponds to a layer of a trained machine learning model. Lenses are provided for each photon directing device, which are formed based on weights of a layer of the trained machine learning model corresponding to the respective photon directing device. The examples may also include optical sensors that correspond to inferences of the trained machine learning model, and the photon directing devices may be configured to receive light of an input and direct the light to one of the optical sensors according to the trained machine learning model.

### BACKGROUND

Artificial neural networks (ANN) and machine learning algorithms have the ability to learn from large data sets. ANNs are computing systems inspired by biological neural networks. The systems consist of a collection of connected nodes or neurons. Each neuron includes linear weights, a summation, and a nonlinear activation, which is a building block in ANNs that enables complex mappings between inputs and outputs for learning tasks. The neurons can be trained using training data that is applied to a machine learning algorithm to create a machine learning model.

### BRIEF DESCRIPTION OF THE DRAWINGS

The present disclosure, in accordance with one or more various implementations, is described in detail with reference to the following figures. The figures are provided for purposes of illustration only and merely depict typical or example implementations.

FIG. 1A is an example of an optical device for activating a neural network in accordance with the presently disclosed technology.

FIGS. 1B-1D are schematic diagrams of example photon directing devices that can be included in the optical device of FIG. 1A.

FIG. 2 is a flow chart of an example process for creating an optical device in accordance with the presently disclosed technology.

FIG. 3. depicts an example use case of an optical device in accordance with an example implementation of the presently disclosed technology.

FIG. 4 is an example computing component that may be used to implement various features of activating a neural network in accordance with the implementations disclosed herein.

FIG. 5 is an example computer system that may be used to implement various features of the optical devices of the present disclosure.

The figures are not exhaustive and do not limit the present disclosure to the precise form disclosed.

### DETAILED DESCRIPTION

Driven by growing interest in artificial intelligence (AI), the global artificial neural network market is projected to grow at a significant rate. As described above, ANNs, machine learning, and deep learning algorithms, implemented as computing systems, that can be trained from large data sets.

Deep learning (also referred to as deep neural networks or DNN) is based on ANNs and feature learning. Feature learning is a set of techniques that allows a system to automatically discover representations for feature detection or classification from input data, such as training, testing, and/or runtime data. Deep learning uses multiple layers to progressively extract higher-level features from raw input data for recognizing or classifying the raw input data. The multiple layers may include, but are not limited to, one or more fully-connected layers, one or more convolutional layers, one or more pooling layers, one or more recurrent layers, one or more normalization layers, or combinations thereof. For example, in image processing applications, lower layers, such as convolutional layers, may identify edges, while higher layers may identify concepts relevant to a human such as objects, characters, or faces. The output from a convolutional layer may be fed to a fully-connected layer.

Conventionally, DNNs have been implemented as electronic machines. A DNN comprises multiple hidden layers between an input layer and an output layer. While there are different types of DNNs, each type includes neurons, synapses, weights, biases, and activation functions as building blocks. The DNN is trained to recognize and/or classify contents represented in the input data and infer a classification, which is applied to the input data as a label, bypassing the input data through the multiple layers to detect features from the input layers. The input data is generally supplied as pixel values pulled from image data containing objects. A DNN can be trained to infer a classification from the input data by calculating a probability that the contents of the input data is one object and a probability that the contents is another object. The DNN then classifies the object by outputting a digital label indicating a classification according to the higher probability at the output layer.

DNNs are typically feedforward networks in which data flows from input layer to output layer acted upon by each hidden layer in series. Each hidden layer performs a mathematical manipulation on data output by a preceding layer to extract features. During a design phase, a DNN model is built through a machine learning algorithm that maps neurons to each hidden layer. Training data can be applied to the algorithm during this design phase, whereby the DNN model learns and assigns numerical values (“weights”) to connections between neurons on adjacent layers to generate a trained DNN model. Hidden layer can include a number of neurons with connections between the various layers. The trained DNN model can then be validated by applying test input data to the trained DNN model, and the outputs evaluated for accuracy. Based on the evaluation, the weights can be adjusted so to retrain and update the DNN model to improve the performance (e.g., accuracy in classification).

Conventionally, DNNs (and ANNs generally) are numerically created and trained for inferring a classification from input data, and then deployed into production electronic machines (e.g., computers, servers, etc.) as executable code. Input data is then applied to the executable code, during a run-time phase (also referred to as an inference phase) to calculate probabilities and output a classification of the input data as a label based on the probabilities. As alluded to above, in the case of classifications for input images, conventional DNNs (and ANNs generally) rely on numerical training data in the form of pixel values (e.g., numerical values within a range of 0 (black) to 255 (white)) for each color channel (e.g., red, green, blue (RGB) channels) defining an input image. The testing and inference phases of conventional DNNs also rely on data supplied in this numerical format. Thus, for large DNNs that involve many layers, the calculations can take time to solve, resulting in delays between input and inference. For example, DNNs can have many layers, e.g. dozens to hundreds of layers, resulting in a delay e.g., tens of milliseconds between input and inference. Furthermore, the run-time machines that are used to perform these large and complex calculations consume power, which can be proportional to the amount of time for performing the calculation. As the complexity of the calculations increases in line with the number of layers, power consumption to perform a classification also increases.

The presently disclosed technology overcomes these technical shortcomings by providing an all-optical transport implementation of an inference engine capable of performing inferences in the optical domain, without converting to a computational or electrical domain. Implementations of the disclosed technology can receive an input in the optical domain as an optical signal, apply weights for each hidden layer in the optical domain, and output a classification as an output optical signal. The output optical signal can then be converted to the electrical domain for generating labels and storing, in some examples. In other examples, the output optical signal can be fed downstream to a subsequent network for further classification.

According to example implementations, optical devices are provided for activating a neural network (NN), such as, but not limited to, a DNN. Activating an NN can refer to outputting a signal corresponding to a classification that causes the NN to label the input according to an inferred classification. The optical devices disclosed herein use weights, learned during a training phase, for each hidden layer of a trained NN model to form photon directing devices, each of which corresponds to a hidden layer and represents numerical weights for that hidden layer. The photon directing devices are positioned along a central or common optical axis having a gap (or space) between each lens array. The photon directing devices can be positioned in series according to the order of the corresponding hidden layers. A plurality of optical sensors are provided at the output of the last photon directing devices, where each optical sensor corresponds to a classification that the NN model is trained to infer.

In an example implementation, each photon directing device may be a lens array that comprises a plurality of lenses arranged and having structural and optical properties formed so to implement the functions of the learned weights by mimicking the connections defined by the learned weights. For example, implementations disclosed herein may mimic a rectified linear unit (ReLU) activation function or the like. In an illustrative example, each lens array may be provided as a lenticular lens comprising a plurality of lenses, such as but not limited to, lenslets or microlens. In some cases, each photon directing device may be provided as a single sheet of material having the array of lenses formed therein (e.g., as peaks and valleys in the material). As another example, each photon directing device can be provided as an array of separate lenses. The materials from which the photon directing devices are formed may include, but are not limited to, acrylic, glass, polycarbonate, or any material traditionally used in lens manufacturing.

In some examples, each photon directing device comprises a plurality of lenses (or lenslets) formed by varying a thickness of the material from which the photon directing device is formed according to the weights of a corresponding hidden layer. By varying the thickness of the material, individual lenses can be formed having focal points selectively positioned according to the weights of the trained NN. The plurality of lenses can comprise concave lens(es) for focusing light, convex lens(es) for defocusing light, or non-curved lens (e.g., lens formed of planer surfaces) to transmit light to the next layer. Additionally, each lens may comprise an individual optical axis. One or more individual optical axes of the lenses can be tilted with respect to the common optical axis by varying the thickness of the one or more lenses, thereby directing light to varying positions on a subsequent photon directing device and/or optical sensor. As such, each respective photon directing device comprises a unique set of lenses formed according to the weights of a corresponding hidden layer of the trained NN model.

In operation, an input optical signal may be provided as light representing an input image. The light of the input signal can be focused onto a first photon directing device (e.g., an input photon directing device) of the optical device and directed to the next photon directing device via the plurality of lenses of the first photon directing device, and so on until a final photon directing device (e.g., an output photon directing device) directs light to a plurality of optical sensors. The shape of each photon directing device and the lenses thereof direct incident light to the next photon directing device according to the trained weights from which the photon directing device is formed. The final photon directing device directs light to a subset of optical sensors, which activates the NN by triggering an optical sensor denoting an inferred label.

Accordingly, instead of inputting pixel values into a numerical NN model, implementations of the present disclosure utilize the optical domain and selectively alter the optical properties of an input image to perform an inference. By using light passing through photon directing devices, the inference can be near instantaneous, constrained by the speed of light. Whereas, with a numerical calculation, the information may pass through many processing units and memory registers to create the output. Even where multiple hidden layers can be mathematically summarized in a single layer and executed numerically, the present disclosure provides advantages in terms of time for inference as the single numerical layer would be computationally complex, thereby consuming computation resources and power to perform the calculations. Furthermore, with the disclosed technology, multiple inputs can be pipelined and passed through the photon directing devices at the same time. Whereas, with a fixed amount of computing resources, only one result can be calculated at a time in the case of a numerically calculated inference.

Furthermore, implementations according to the present disclosure consume minimal power as a result of performing inferences in the optical domain. An input optical signal can be passed through uniquely designed photon directing devices, which perform the calculations without consuming additional power. The inference is determined by passing light of an input through the photon directing devices and through detection by an optical sensor. Passing the light through the photon directing devices consumes no additional power, while detection by an optical sensor consumes minimal power as it detects incident optical signals and converts the detected signal to an electrical domain for labeling and storage. Whereas, in the case of numerically calculated inferences, power is consumed in converting light from input into the electrical domain, as well as during each calculation of the inference.

Other benefits achieved by the presently disclosed technology includes miniaturization of NN networks through lens. For example, both numerically calculated and optical solutions can be miniaturized, but this miniaturization is easier to execute with optical solutions since there is no power consumption or cooling considerations to account for. Thus, complexity in reducing the size and overall footprint can be simpler to execute.

Further still, when an NN is deployed, there is a chance that the model can be reverse engineered to discover the weights used in the model and to copy the model. By hiding the weights in the formation of the lens arrays, the weights themselves are significantly more difficult to derive from the system. For example, in any digital solution, a software or firmware digital file is used to load the model into the digital hardware. To encrypt data, the data is loaded into memory. This storage of the data leaves the model exposed to be copied. With the optical solution disclosed herein, an optical device is provided that would have to be physically disassembled and analyzed with very specialized tools to reverse engineer the design of the photon directing devices and their relative orientations within the optical device.

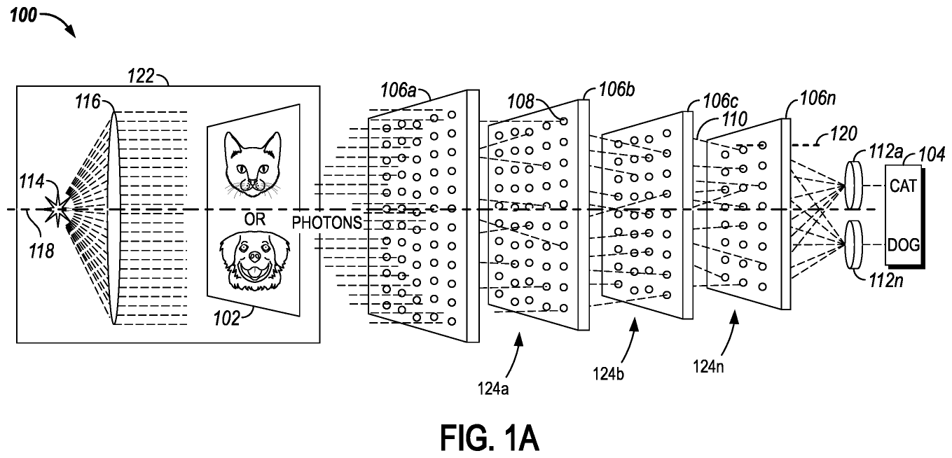

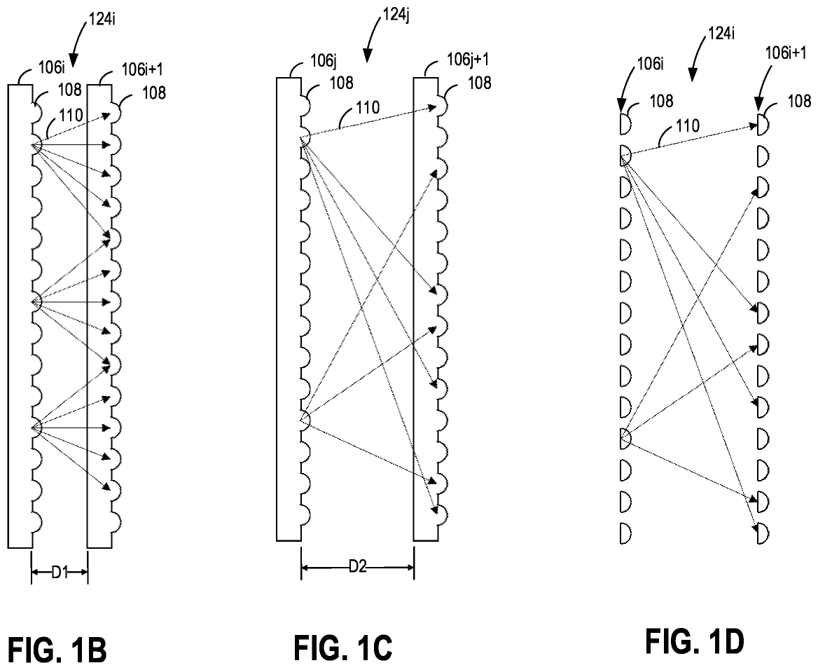

FIG. 1A is an example of an optical device 100 for activating an NN in accordance with the presently disclosed technology. Optical device 100 comprises a plurality of photon directing devices 106a-106n (collectively referred to herein as photon directing devices 106) disposed along a central optical axis (also referred to as common optical axis) 118, with gaps (or spaces) 124a-124n (collectively referred to herein as gap 124) between the photon directing devices 106. The gaps 124 may be uniform or non-uniform gaps. FIGS. 1B-1D are schematic diagrams of example photon directing devices 106 having a plurality of lenses 108 formed thereon.

Each photon directing device 106 corresponds to a hidden layer of a trained NN model, such as but not limited to, a DNN or the like. Each photon directing device 106 can be implemented as a lens array and comprise a plurality of lenses 108, represented circles. The lenses 108 may be lenslets (also referred to as microlenses) in some examples. While only one lens 108 is labeled in FIG. 1, this is for illustrative purposes only to provide for clear and legible figures. Each circle illustrated in FIG. 1A represents a lens. While a certain number of block dots are shown in each photon directing device 106, this is for illustrative purposes only to facilitate ease of understanding. Each photon directing device 106 may comprise any number of circles according to the number of lenses for mimicking the corresponding hidden layer.

The plurality of lenses 108 of a respective photon directing device 106 are formed according to weights of a hidden layer corresponding to the respective photon directing device 106. While four photon directing devices 106 are illustrated in FIG. 1, this is for illustrative purposes only and the present disclosure is not limited to four photon directing devices. Any number of photon directing devices 106 may be provided as desired for a given application, such that the number of photon directing devices 106 corresponds to the number of hidden layers of a trained NN. Optical device 100 also comprises a plurality of optical sensors 112a-112n (collectively referred to herein as optical sensors 112), each corresponding to an inference of the trained NN model.

As discussed above, an NN model can be built from a machine learning algorithm that maps neurons to hidden layers and weights learned during a training phase assigned to connections between neurons of neighboring layers. Each neuron in one layer can be connected to one or more neurons, and in some examples, neurons of the next layer in series. Weights for each connection are thus assigned based on the training. For each hidden layer, the trained weights can be used to define the shape of lenses 108 of a photon directing device 106 corresponding to the hidden layer such that light incident on a given lens 108 is directed, traversing the gap 124 between adjacent photon directing devices 106, to a next lens (e.g., neuron), according to the optical shape and properties of the lens 108 defined by the trained weight. As such, each lens 108 may correspond to a neuron of the corresponding hidden layer, and the lens 108 acts on incident light so to direct the light to the next lens 108 (e.g., neuron) on the next photon directing device 106 according to the trained weights for the connection between the neurons. Illustrative examples of this are shown in FIGS. 1B and 1C.

The shape of the lens, which directly impacts the optical properties of light that propagates through the optical device 100, may be defined based on the weights. While specifics as to how a given weight (numerical value) is imparted into a lens can be implementation specific, the weights can be used to define a curvature of a lens, such as but not limited to, whether the lens is concave or convex, as well as the radius of curvature for adjusting a focal point. Accordingly, weights can be used to define a focusing or de-focusing power of a lens to provide a smaller focal point (more focused) or larger focal point (defocused), or no focus on the next lens. In another example, each lens comprises an individual optical axis (e.g., axis 120) associated therewith and the shape of the lens can be altered, according to the weights, so to tile the optical axis relative to the common optical axis 118. Through control of the focal power, shape, and optical axis tilt, connections between the neurons achieved via the lens can be strengthened and/or weakened in accordance with the trained weights.

The photon directing device 106 may be formed from a single sheet of material, as shown in the examples of FIGS. 1B and 1C. The thickness of the material may be selectively varied across the sheet so to provide for deformations or bumps (e.g., peaks and valleys), each of which constitutes a corresponding lens. That is, selectively forming deformations on the sheet can provide for shapes of the lenses 108. The material may be acrylic, glass, or any material traditionally used in lens manufacturing. The deformations may be manufactured through additive processes, such as but not limited to 3D printing techniques. In another example, the deformations may be formed using subtractive techniques, such as but not limited to milling machining techniques. In some implementations, each photon directing device 106 may be molded from the material, forged, manufactured according to any techniques known in the art, or a combination of manufacturing processes.

The photon directing devices 106 may be relatively thin, thereby enabling dense structures having many layers within a small physical space. For example, in the case of photon directing devices implemented as acrylic sheets, each acrylic sheet may be 1.5 mm thick along the optical axis 118.

In operation, the photon directing devices 106 are configured to receive an input optical signal representing an input image 102 from an input layer 122. The photon directing devices 106 may direct photons from the input optical signal to the plurality of optical sensors 112 passing through the photon directing devices 106 according to the trained NN model. The optical sensor 112 that detects the largest output signal activates the NN by triggering a classification according to the classification associated with the optical sensor 112. In an example, the optical sensor 112 having the largest signal activates the NN and triggers a conversion of the optical domain to the electrical domain, which generates a label at an output layer 104 according to the classification associated to the triggered optical sensor 112. In some implementations, the NN is triggered only if the optical signal detected at the optical sensors exceeds a threshold intensity. For example, if optical sensor 112a detects the largest optical intensity relative to optical sensor 112n, but, if the intensity detected by optical sensor 112a does not exceed the threshold, the NN may not be activated as the detected signal was not large enough to qualify as an inference. In this case, a failure or other notification can be generated to notify a user that an inference is not possible.

In the example of FIG. 1, the input layer 122 comprises a light source 114 configured to emit light that is collimated by a collimating lens 116. The collimating lens directs the light to illuminate an image 102. In the example of FIG. 1, the image can be a transparency based image having an object formed by opaque and transparent portions of the image. The transparent image permits light from the light source 114, collimated by collimating lens 116, to pass through the image and irradiate a first photon directing device 106a (e.g., input photon directing device) with light representing the object of the image. In another example, image 102 may be a picture or other visual medium that reflects the light of the image to the input photon directing device 106a.

In the example of FIG. 1, the NN model is trained to recognize whether image 102 contains a cat or dog. The photon directing devices 106 are created based on the trained weights as described above. Light from image 102, either a transmissive or reflective image, illuminates input photon directing device 106a, which acts on the light according to the trained weights used to create the lenses 108 of input photon directing device 106a. The lens of input photon directing device 106a directs the light to the next photon directing device 106b, and the lenses 108 of the next photon directing device 106b act on the light, and so on until the final photon directing device 106n (or output photon directing device). Each photon directing device 106 therefore acts as an optical filter according to the trained weights of the corresponding hidden layer so to direct light from each lens 108 to the next lens according to weighted connections.

At the output photon directing device 106n, the lenses 108 direct light to one or more of the plurality of optical sensors 112a-112n. The optical sensors 112a-112n may be, for example, photodiodes or any optical sensor known in the art. In this example, two optical sensors 112a and 112n are provided: one associated with an inference of cat (e.g., optical sensor 112a) and the other associated with an inference of dog (e.g., optical sensor 112n). As described above, the optical sensor 112a or 112n that detects the highest intensity is triggered, which activates the NN to label image 102 as the associated label. For example, if optical sensor 112n detects a higher intensity than optical sensor 112a, the NN is activated and labels image 102 as a dog. In some examples, a threshold may be applied that may be exceeded so to activate the NN (e.g., optical sensor 112n in this example detects an intensity that exceeds the threshold to activate the NN), otherwise, the NN is not activated as an inference cannot be made.

In some implementations, the optical device 100 may be implemented using a plurality of polarizations. For example, the lenses 108 can comprise linear polarizers (such as, but not limited to, acrylic linear polarizers) that act on light with one polarization according to one set of weights, and light with a different polarization according to a different set of weights. This would allow the optical device to perform inference according to multiple NN models at the same time. That is, for example, a plurality of the NN model may be trained to provide a plurality of sets of weights. Each NN model can then be associated with a polarization of light and the lens formed so to act on the light of the first polarization according to one set of weights and act on the light of the second polarization according to another set of weights.

In another example, optical device 100 may be implemented using a plurality of electromagnetic wavelengths, each associated with a different NN model. For example, a first NN model may be associated with a first wavelength of light (e.g., x-ray, ultraviolet, visual, and/or infrared wavelengths), a second NN model may be associated with a second, different wavelength, and so on. Then, similar to the above example, the lenses 108 may be formed so to act on a first wavelength according to weights for the first NN, act on a second wavelength according to weights of the second NN, and so on.

Each gap 124 between the photon directing devices 106 may be an air gap or filled with a transparent or semi-transparent material. The gaps 124 may comprise transparent or semi-transparent materials. Examples of transparent materials can include, but not limited to, vacuum; air; inert gases such as, but not limited to, helium, nitrogen, argon, and the like; water; alcohol; mineral oil; and glycerin. Examples of semi-transparent materials can include, but not limited to, vellum, rice paper, stained glass, and mylar. Different materials have different indexes of refraction, which can be leveraged to bend light traversing the gap 124 according to the index so to direct the light to desired areas of the next photon directing device 106.

In some implementations, the gaps 124 between the photon directing devices 106 can be varied to achieve varying thicknesses of the optical device 100. In some implementations, the gaps 124 may be varied to provide a geometry that enables connections between neurons. For example, if neurons on a given hidden layer are to send strong signals to neurons in close proximity on the next hidden layer, then the gap 124 could be relatively small. Whereas, if the neurons are to send a strong signal to neurons that are further away on the next hidden layer, a relatively wider gap 124 may be provided to provide sufficient space so that the signals can reach the neurons on the next hidden layer.

For example, FIGS. 1B and 1C are schematic diagrams of photon directing devices 106 implemented as sheets of material having a plurality of lens 108 as bumps on each sheet and different gap sizes (or distances) therebetween. FIGS. 1B and 1C illustrate a photon directing device 106i and 106j, respectively, that may represent any one of photon directing devices 106a-n and a photon directing device 106i+1 and 106i+1, respectively, that represents any one of photon directing devices 106b-n that is adjacent to the photon directing device 106i and 106j, respectively. FIG. 1B illustrates a case where lenses 108 on photon directing device 106i are connected to lenses 108 on photon directing device 106i+1 that are relatively proximate to each other and thus the connections 110 are relatively short. As such, the gap 124i may have a distance or size D1. Whereas, as shown in FIG. 1C, lenses 108 on photon directing device 106j are connected to lenses 108 on photon directing device 106j+1 that are relatively farther away from each other and thus the connections 110 are relatively longer. As such, the gap 124j may have a distance or size D2. In these examples, the distance D1 is shorter than the distance D2.

While the examples of FIGS. 1B and 1C illustrate lens 108 as bumps on a certain side of a photon directing device 106, this is for illustrative purposes only. Lenses 108 may be formed on either or both sides of photon directing device 106. Furthermore, while FIGS. 1B and 1C show photon directing device 106 as sheets of lenses 108, as noted above this is only one example implementation and each photon directing device 106 may be implemented as a lens array of individual lenses that spaces apart in directions perpendicular to the common optical axis 118, as shown in FIG. 1D.

In some implementations, one or more mirrors may be provided along the common optical axis 118 to reflect light for a configurable footprint of the optical device 100 and direct around corners. The mirrors may be any mirror known in the art and may be positioned anywhere along common optical axis 118. For example, between two adjacent photon directing devices 106, between the image 102 and input photon directing device 106a, between the output photon directing device 106n and the photosensors, or combinations thereof. Thus, the optical device 100 may have any shape desired and need not be a single straight linear construction.

In another example, the optical device 100 may be surrounded in a radial direction of the common optical axis 118 and/or fully enclosed within a reflecting material. In this case, stray light may be reflected back into the optical device 100 to provide a maximum optical power that traverses the layers.

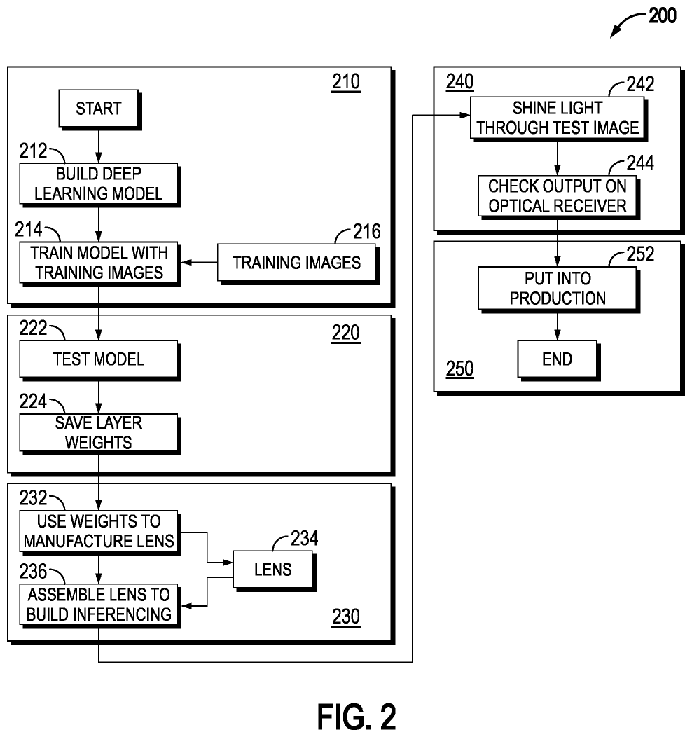

FIG. 2 is a flow chart of an example process 200 for creating optical device 100 in accordance with the presently disclosed technology. The process 200 comprises various phases: a training phase 210, a testing phase 220, a manufacturing phase 230, a verification phase 240, and a run-time phase 250. During the training phase 210 a machine learning model is built from a machine learning algorithm by applying a training data set to the machine learning algorithm to the algorithm to learn and assign weights to connections between neurons on adjacent layers. The training phase 210 generates a trained machine learning model that can be tested during the testing phase 220 by applying a testing data set to the trained machine learning model. During the testing phase 210, the trained machine learning model outputs inferences, which are evaluated for accuracy in the inferences (e.g., is the inference correct). During the manufacturing phase 230, an optical device 100 is manufactured based on the trained machine learning model. The optical device 100 can be verified that it performs as designed during verification phase 240. During the run-time phase 250, the optical device 100 can then be put into production for use in executing inferences.

More particularly, at operation 212 the machine learning model is built. According to various implementations, the machine learning model can be a NN model, a DNN model, or the like. For example, a machine learning algorithm can be executed to map neurons to hidden layers of a DNN, along with mapping connections between neurons of adjacent hidden layers. Furthermore, connections from a final, output hidden layer can be mapped to a plurality of inferences for labeling.

At operation 214, training data sets 216 are applied to the machine learning algorithm to train the machine learning model. During the operation 214, weights for connections between neurons are learned and assigned to the mapped connections. Training can be performed using supervised learning (e.g., using labeled training data sets), unsupervised learning (e.g., unlabeled training data sets), or a combination thereof. In either case, weights can be learned for connections using any training methodologies known in the art and applicable to the machine learning model being trained.

The training data sets may comprise images or pixel values extracted from digital images. In the case of images, pixel values are extracted from each image. In either case, pixel values are supplied to the machine learning model to numerically learn the weights for inferring a classification (or label) of the machine learning model.

At operation 222, the machine learning models may optionally be tested using testing data sets. Testing data sets may be similar to the training datasets and applied to the trained machine learning model to test the accuracy of the inferences calculated by the trained machine learning model. The testing data sets may be different data provided in the same format (e.g., images and/or pixel values) as the training dataset. If the accuracy is below an acceptable threshold, the machine learning model may be retrained by repeating operation 214. Otherwise, the learned weights are extracted and saved to a memory. The weights may be saved as a data structure, in which neurons of each hidden layer are linked via a connection, and learned weights are associated with each connection.

In some implementations, at operation 224, the trained machine learning model will have a number of hidden layers, and each hidden layer will have a size defined by the number of neurons for that hidden layer. Each neuron can be associated with one or more weights of the learned weights and mapped to a location within the hidden layer. The data structure can provide for this mapping of locations for each neuron within a hidden layer relative to the other neurons of that hidden layer. The locations may be defined in a planar coordinate system representative of the hidden layer, with relative locations between neurons given in arbitrary units of length. This mapping of locations of the neurons on the hidden layer can be used to define physical locations for the lens within a photon directing device that corresponds to the hidden layer, as described below.

The learned weights can be associated with neurons and the mapped location of that neuron. The value of the learned weight represents a connection between the associated neuron and another neuron of an adjacent hidden layer. The learned weight can be a measure of the amount of optical signal that is to be transmitted along an optical path between the associated neuron and the other neuron. As an illustrative example, the amount of optical signal to be transmitted can be treated as a mathematical normal that is perpendicular to a tangent of a curve. This geometric normal and tangent can be converted into a curvature of a lens to be formed on the photon directing device corresponding to the hidden layer in the direction toward the other neuron.

At operation 232, the learned weights are used to manufacture the photon directing devices of the optical device 100. More particularly, operation 232 may include designing or otherwise defining the optical properties of each photon directing device. For example, the learned weights from operation 214 and saved at operation 224 can be used to define shapes and optical properties of the lens of the photon directing devices. That is, a learned weight of a connection from a neuron of a given hidden layer to the neuron of an adjacent hidden layer can be converted to parameters for shaping a lens corresponding to that neuron to direct light along the connection according to the learned weights. For example, as described in the illustrative example above, the learned weights may define an amount of optical signal to be transmitted between neurons and can be used to define a geometric normal and tangent that can be converted into a curvature of a lens to be formed on the photon directing device.

The process may be repeated for each connection of the given hidden layer. In an example implementation, the data structure from operation 224 can be retrieved and accessed to define physical locations of each lens in a photon directing device so to represent the neurons of a corresponding hidden layer. The physical dimensions may be dependent on the implementation, but the arbitrary units of lengths can be normalized according to the desired dimensions of the photon directing device. In any case, the learned weights associated with connections for each location (e.g., neuron) can then be used to define a shape (e.g., focal power, concave, tilt, convex, etc.) or other optical parameters (e.g., polarization, wavelength, etc.) that directs light along the vectors representing each connection. This is repeated for each hidden layer of the trained machine learning model.

At operation 232, various other aspects of the optical device 100 can be defined. For example, distances between photon directing devices, materials used for each lens (which may be the same or different materials depending on the implementation), overall dimensions of the optical device 100, inclusion of mirrors or other reflective materials for bending or controlling escaping light, inclusion of other materials or gases in the gaps between lens, or any other aspects that one would desire to define in manufacturing a lens system.

At operation 234, each lens is physically manufactured according to the design from operation 232.

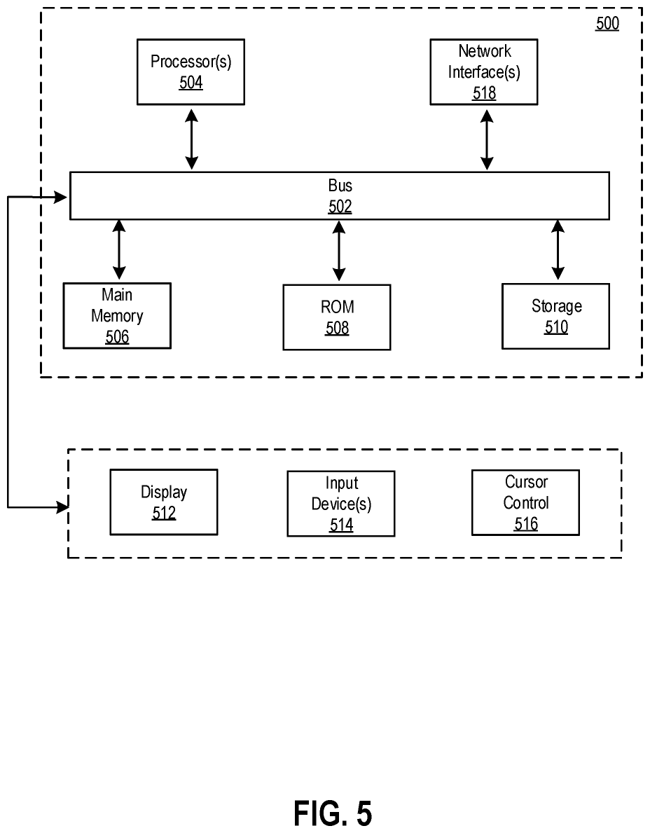

At operation 236, the optical device 100 is assembled and built into an all optical inferencing engine. At this stage, the various photon directing devices are aligned along a common axis (straight or bent using one or more mirrors). The photon directing devices are also aligned with one or more optical sensors that are associated with labels for which the optical device 100 is designed to infer. The association may be a manual association, whereby a user enters a label according to an output signal detected at the optical sensors. In another example, the association may be electrical, computational, or otherwise automated, whereby the optical signals generate a classification signal according to which the optical signal triggers activation of the machine learning model. The classification signal may be provided to a computer system, such as the computer system 500 of FIG. 5, which labels input data according to the inferred classification.

At operation 242, a test image is supplied to the optical device 100 by emitting light either through the test image (e.g., a transparent test image) or emitted towards the test image to reflect light to the optical device 100. In either case, the test image is applied to the optical device 100 as photons that pass through the various photon directing devices so to mimic the functions of the hidden layers. From the final, output photon directing device, light is directed to the optical sensors which activates the machine learning model according to which optical sensor detects the most light (and/or the most light while also exceeding a threshold).

At operation 244, the output from the optical sensors is checked to confirm that the label inferred by the optical device 100, as indicated by the classification signal, is correct. That is, the test image may be labeled and the classification signal, which indicates an inferred label, can be checked against the known label. Operation 244 may be repeated any number of times to confirm a desired robustness (e.g., percentage of tests that resulted in a match). Once confirmed, the process proceeds to operation 252 and the optical device 100 is put into production for use in executing inferences.

If a match is not found (or a desired robustness is not achieved), the process 200 may return to any point along the process so to recreate the optical device 100. For example, process 200 may return to operation 232 and/or operation 234 to manufacture the optical device 100 (or one or more photon directing devices) again in the case of a manufacturing defect in the photon directing device. Process 200 may return to operation 236 in the case of an alignment error. Further still, process 200 may return to operation 212 and/or operation 214 to retrain the model for refining the resulting inference.

In some implementations, a tuning operation could be included after operation 252. Over time, after retraining, the learned weights may change. In this case, one or more photon directing devices could be removed individually and remanufactured according to the updated weights. The updated photon directing device could then be inserted back into position within optical device 100.

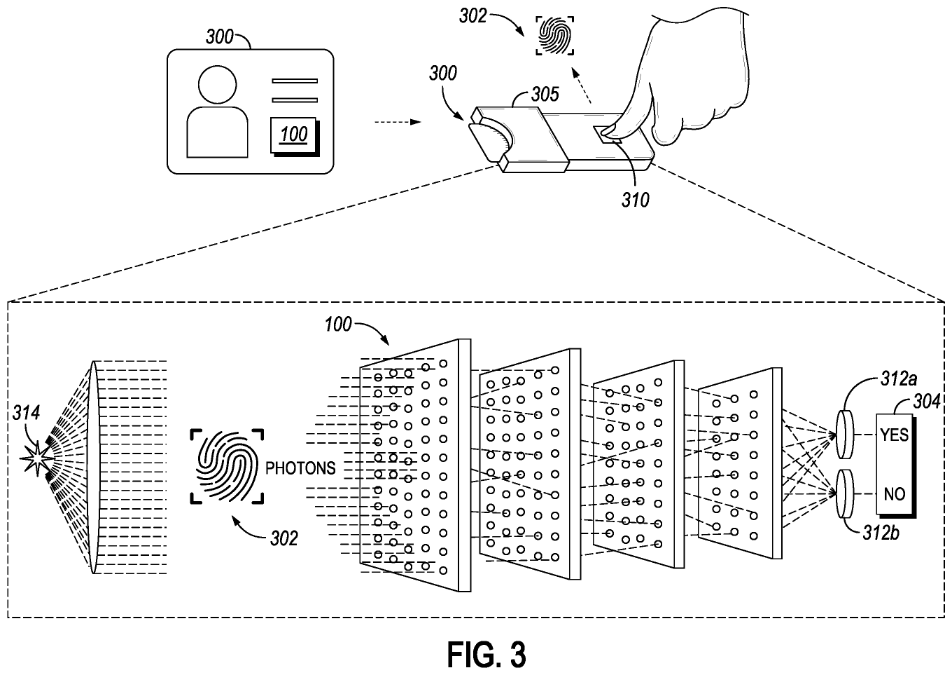

FIG. 3 depicts an example use case of optical device 100 in accordance with an example implementation of the presently disclosed technology. FIG. 3 illustrates a scenario in which optical device 100 can be utilized for authenticating personnel by providing an optical device 100 in an identification (ID) device 300 issued by a company, bank, government entity, etc. In the example of FIG. 3, the ID device 300 is an ID card that can be inserted into a card reader 305. Card reader 305 can also receive a biometric scan 302 from a biometric scanner 310 through either a wired or wireless communication interface between biometric scanner 310 and card reader 305. Card reader 305 can be configured to utilize the optical device 100 on the ID device 300 to authenticate the biometric scan.

The optical device 100 included in ID device 300 can be encoded with one or more biometrics of an authorized personnel. For example, a NN can be trained to recognize whether an input biometric, for example but not limited to, a fingerprint, signature, face, genome, iris, etc., belongs to an authorized personnel. That is, an NN model can be built to recognize one or more authorized biometrics for a given personnel and trained so to learn weights to infer whether an input biometric matches the biometrics for which the NN was built. Recognizing biometrics may be treated as a binary inference, where the optical device is trained to classify an input biometric as Yes (e.g., authenticated or matches an encoded biometric) or No (e.g., not authenticated or does not match), which can be output as an authentication result (e.g., a label). The learned weights can then be used to manufacture the optical device 100, as described above, such that the trained NN is encoded into the optical device 100. While the optical device 100 on card ID device 300 is encoded with a neural network configured to recognize a biometric, no real biometric information is needed to be saved to ID device 300.

In operation, the ID device 300 having optical device 100 included therein can be inserted into card reader 305. Card reader 305 can also receive a live biometric scan from the biometric scanner 310 based on user interaction with the biometric scanner 310. For example, biometric scanner 310 in this example is a fingerprint scanner that reads a fingerprint. Card reader 305 then provides live biometric scan 302 (also referred to as an input biometric) as an input image to optical device 100. That is, in the case of a fingerprint scan, the fingerprint can be provided as a reflected light used to scan the user's finger, an image capture of the finger that is then presented to optical device 100, passing of a bar of light across the fingerprint to copy the fingerprint, or other means of presenting the biometric scan in the optical domain. The light representative of the live biometric scan 302 is then passed through optical device 100 and learned weights applied as described above, which directs the light optical sensors 312a and 312b. Optical device 100 can then activate the NN to authenticate the user or not based on which of the optical sensors 312a or 312b detects the most intensity. As described above, the activation of the NN may be based on a threshold intensity as well. Thus, optical device 100 can infer whether the live biometric scan 302 matches the encoded biometric and authenticate the user (e.g., Yes at output layer 304). Otherwise, if optical device 100 infers that there is not a match, the user is not authenticated (e.g., No at output layer 304).

In the example of FIG. 3, the biometric scanner 310 and the card reader 305 are a single integrated device. In this case, biometric scanner 310 may comprise a light source 314 that scans a user's finger. Light from light source 314 can be reflected by the live biometric scan 302 and directed to optical device 100 providing a reflective configuration. In another example, a transmissive configuration may be provided whereby an image of the live biometric scan 302 is captured by biometric scanner 310 and then used by card reader 305 as an input image. This input image may be a transparent image and card reader 305 may include light source 314 to illuminate the image.

In some implementations, different security protocols (e.g., different levels of clearance and/or privacy) may be encoded into a single optical device 100. For example, as described above, different polarizations and/or wavelengths can be used to encode multiple NNs into a single optical device 100. In this case, different security protocols can be activated using distinct NNs encoded according to different polarization and/or wavelengths. That is, for example, a low level security protocol can be activated using a first polarization or first wavelength, while a higher level security protocol activated using a second polarization or second wavelength. Thus, by using light sources emitting different polarizations and/or wavelengths of light, different levels of security can be activated with a single optical device 100. A similar implementation can be used to activate different biometrics, that a fingerprint may be encoded into optical device 100 for a first wavelength of light (or polarization), while an iris may be encoded into optical device 100 for a second wavelength (or polarization).

While the example in FIG. 3 is described with reference to biometric scanner 310 as a fingerprint scanner, this is intended as an illustrative example only for ease of understanding. Other implementations are possible. For example, biometric scanner 310 could be implemented as a camera for facial recognition; a touch pad of a mobile phone, tablet, or other computing device; or any device capable of receiving a biometric of a user based on user interactions therewith. Furthermore, while ID device 300 is described as an ID card in this example, ID device 300 is not intended to be limited to ID cards, which is provided as an illustrative example. Any device capable of carrying an optical device 100 encoded with one or more biometrics of an authorized personnel can be used. Additionally, card reader 305 may be any device capable of applying an input optical signal of a biometric scan received from a biometric scanner 310 to the ID device 300 such that the input optical signal illuminates the optical device 100. Furthermore, card reader 305 and biometric scanner 310 may be communicatively coupled through a wired or wireless connection, as well as integrated into a single device body or remote from each other.

As another example use case may include leveraging optical device 100 in an electron microscope and triggering optical device 100 when a specific image or pattern is seen in a beam of the electron microscope. For example, the input image may be a sample under examination and the optical device 100 may be encoded to detect one or more specimens within the sample. The optical device 100 may be inserted along an x-ray beam of the electron microscope, which is input into the optical device 100 and processed as described above. The optical device 100 may be triggered if the input beam from the sample matches an encoded image or pattern of one or more specimens.

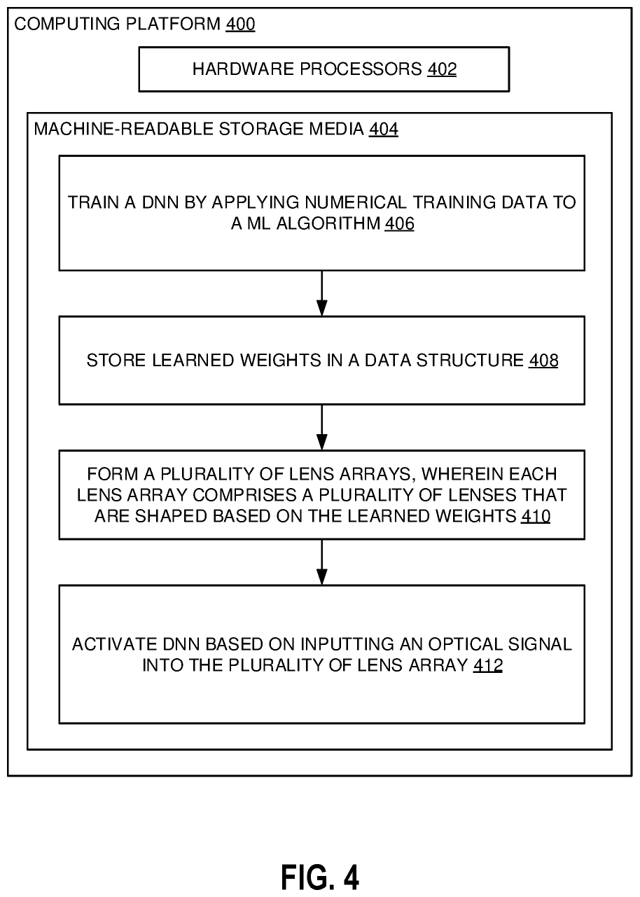

FIG. 4 illustrates an example computing component that may be used to activate an NN in accordance with various implementations. Referring now to FIG. 4, computing component 400 may be, for example, a server computer, a controller, or any other similar computing component capable of processing data. In the example implementation of FIG. 4, the computing component 400 includes a hardware processor 402, and a machine-readable storage medium for 404.

Hardware processor 402 may be one or more central processing units (CPUs), graphical processor units (GPUs), semiconductor-based microprocessors, and/or other hardware devices suitable for retrieval and execution of instructions stored in machine-readable storage medium 404. Hardware processor 402 may fetch, decode, and execute instructions, such as instructions 406-412, to control processes or operations for activating a DNN. As an alternative or in addition to retrieving and executing instructions, hardware processor 402 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 404, may be any electronic, magnetic, optical, or other physical storage device that contains or stores executable instructions. Thus, machine-readable storage medium 404 may be, for example, Random Access Memory (RAM), non-volatile RAM (NVRAM), an Electrically Erasable Programmable Read-Only Memory (EEPROM), a storage device, an optical disc, and the like. In some implementations, machine-readable storage medium 404 may be a non-transitory storage medium, where the term “non-transitory” does not encompass transitory propagating signals. As described in detail below, machine-readable storage medium 404 may be encoded with executable instructions, for example, instructions 406-412.

Hardware processor 402 may execute instruction 406 to train a DNN by applying numerical training data to a machine learning algorithm. For example, a DNN can be trained as described in connection with FIG. 2. As described above, the DNN network comprises a plurality of hidden layers having connections between adjacent hidden layers, and weights for the connections can be learned from the training.

For example, training data sets can be applied to a machine learning algorithm to train a machine learning model. The machine learning algorithm can be trained to map neurons to hidden layers of a DNN, along with mapping connections between neurons of adjacent hidden layers. Furthermore, connections from a final, output hidden layer can be mapped to a plurality of inferences for labeling. During the training of the machine learning algorithm, weights for connections between neurons can be learned and assigned to mapped connections. Training can be performed using supervised learning (e.g., using labeled training data sets), unsupervised learning (e.g., unlabeled training data sets), or a combination thereof. In either case, weights can be learned for connections using any training methodologies known in the art and applicable to the machine learning model being trained.

The training data sets may comprise images or pixel values extracted from digital images. In the case of images, pixel values are extracted from each image. In either case, pixel values are supplied to the machine learning model to numerically learn the weights for inferring a classification (or label) of the machine learning model.

In some implementations, instruction 406 may include testing the machine learning models using testing data sets. Testing data sets may be similar to the training datasets and applied to the trained machine learning model to test the accuracy of the inferences calculated by the trained machine learning model. The testing data sets may be different data provided in the same format (e.g., images and/or pixel values) as the training dataset. If the accuracy is below an acceptable threshold, the machine learning model may be retrained.

Hardware processor 402 may execute instruction 408 to store the learned weights, for example, in a data structure. Examples of the data structure are described above in connection with FIG. 2.

For example, the learned weights may be saved as a data structure, in which neurons of each hidden layer are linked via a connection and learned weights are associated with each connection. In this case, the machine learning model may have a number of hidden layers, and each hidden layer may have a size defined by the number of neurons for that hidden layer. Each neuron can be associated with one or more weights of the learned weights and mapped to a location within the hidden layer. The data structure can provide for this mapping of locations for each neuron within a hidden layer relative to the other neurons of that hidden layer. The locations may be defined in a planar coordinate system representative of the hidden layer, with relative locations between neurons given in arbitrary units of length. This mapping of locations of the neurons on the hidden layer can be used to define physical locations for the lens within a photon directing device that corresponds to the hidden layer.

The learned weights can be associated with neurons and the mapped location of that neuron. The value of the learned weight can represent a connection between the associated neuron and another neuron of an adjacent hidden layer. The learned weight can be a measure of the amount of optical signal that is to be transmitted along an optical path between the associated neuron and the other neuron. As an illustrative example, the amount of optical signal to be transmitted can be treated as a mathematical normal that is perpendicular to a tangent of a curve. This geometric normal and tangent can be converted into a curvature of a lens to be formed on the photon directing device corresponding to the hidden layer in the direction toward the other neuron.

Thus, information can then be saved as a data structure comprising the neurons of each hidden layer linked via connections, and the learned weights are associated with each connection. The learned weights can be associated with the curvature of a lens, as described above. Additionally, the corresponding neuron and location can be associated with a location on the photon directing device corresponding to the hidden layer, such that the curvature is also associated with the location of the neuron.

Hardware processor 402 may execute instruction 410 to form a plurality of photon directing devices corresponding to the plurality of hidden layers. As described above in connection with FIGS. 1A-3, each photon directing device comprises a plurality of lenses that are shaped based on the learned weights.

For example, the learned weights and curvature of the data structure from instruction 408 can be used to manufacture photon directing devices, such as those described in connection with the optical device 100. Each photon directing device can be designed or otherwise defined by the information included in the data structure. For example, a location of a neuron on a hidden layer can be used to reference the data structure and retrieve learned weights for that neuron. The learned weights can be used to define shapes (e.g., curvature) and other optical properties of a lens to be formed for the photon directing device. That is, a learned weight of a connection from a neuron of a given hidden layer to the neuron of an adjacent hidden layer can be converted to parameters for shaping a lens corresponding to that neuron so to direct light along the connection according to the learned weights. For example, as described in the illustrative example above, the learned weights may define an amount of optical signal to be transmitted between neurons and can be used to define a geometric normal and tangent that can be converted into a curvature of a lens to be formed on the photon directing device.

The process may be repeated for each connection of the given hidden layer. In an example implementation, the data structure can be retrieved and accessed to define physical locations of each lens in a photon directing device so to represent the neurons of a corresponding hidden layer. The physical dimensions may be dependent on the implementation, but the arbitrary units of lengths can be normalized according to the desired dimensions of the photon directing device. In any case, the learned weights associated with connections for each location (e.g., neuron) can then be used to define a shape (e.g., focal power, concave, tilt, convex, etc.) or other optical parameters (e.g., polarization, wavelength, etc.) that directs light along the vectors representing each connection. This is repeated for each hidden layer of the trained machine learning model.

Further, in various examples, other aspects of the optical device 100 can be defined. For example, gap distances between photon directing devices, materials used for each lens (which may be the same or different materials depending on the implementation), overall dimensions of the optical device, inclusion of mirrors or other reflective materials for bending or controlling escaping light, inclusion of other materials or gases in the gaps between lens, or any other aspects that one would desire to define in manufacturing a lens system. Further examples are provided above in connection with FIGS. 1A and 1B.

Once the optical parameters of a given photon directing device is defined, a corresponding lens can be physically manufactured according to the design. Further, once photon directing devices for each hidden layer are fabricated, the optical device can be assembled and built into an all optical inferencing engine. At this stage, the various photon directing devices can be aligned along a common axis (straight or bent using one or more mirrors). The photon directing devices can also be aligned with one or more optical sensors that are associated with labels for which the optical device is designed to infer. The association may be a manual association, whereby a user enters a label according to an output signal detected at the optical sensors. In another example, the association may be electrical, computational, or otherwise automated, whereby the optical signals generate a classification signal according to which optical signal triggers activation of the machine learning model.

Hardware processor 402 may execute instruction 412 to activate the DNN based on inputting an optical signal into the plurality of photon directing devices, for example, as described above in connection with FIGS. 1-3.

For example, a test image can be supplied to the optical device by emitting light either through the test image (e.g., a transparent test image) or emitted towards the test image to reflect light to the optical device. In either case, the test image can be applied to the optical device as photons that pass through the various photon directing devices so to mimic the functions of the hidden layers. From the final, output photon directing device, light is directed to the optical sensors which activates the machine learning model according to which optical sensor detects the most light (and/or the most light while also exceeding a threshold).

In some implementations, the output from the optical sensors can be checked to confirm that the label inferred by the optical device, as indicated by the classification signal, is correct. For example, the test image may be labeled and the classification signal, which indicates an inferred label, can be checked against the known label. If a match is not found (or a desired robustness is not achieved), machine-readable storage medium 404 may repeat any one of operations 406-410 so to recreate the optical device.

FIG. 5 depicts a block diagram of an example computer system 500 in which various of the implementations described herein may be implemented. The computer system 500 may be coupled to optical sensors 112 (or 312) for labeling an input image. As another example, computer system 500 may be implemented as card reader 305 and/or biometric scanner 310. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache, and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to a display 512, such as a liquid crystal display (LCD) (or touch screen), for displaying information to a computer user. An input device 514, including alphanumeric and other keys, is coupled to bus 502 for communicating information and command selections to processor 504. Input device 514 may also comprise a biometric scanner in certain examples and/or a card reader. Another type of user input device is cursor control 516, such as a mouse, a trackball, or cursor direction keys for communicating direction information and command selections to processor 504 and for controlling cursor movement on display 512. In some implementations, the same direction information and command selections as cursor control may be implemented via receiving touches on a touch screen without a cursor.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format for installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs computer system 500 to be a special-purpose machine. According to one implementation, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative implementations, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

The computer system 500 also includes a communication interface 518 coupled to bus 502. In some examples, communication interface 518 may be leverage for communication with optical sensors 112 and/or 312. Network interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. As another example, network interface 518 may be a local area network (LAN) card to provide a data communication connection to a compatible LAN (or WAN component to communicated with a WAN). Wireless links may also be implemented. In any such implementation, network interface 518 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 518, which carry the digital data to and from computer system 500, are example forms of transmission media.

The computer system 500 can send messages and receive data, including program code, through the network(s), network link and communication interface 518. In the Internet example, a server might transmit a requested code for an application program through the Internet, the ISP, the local network and the communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example implementations. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, GPUs, ASICS, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 500.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. An optical device for implementing a neural network, the optical device comprising:
a plurality of photon directing devices disposed along a common optical axis, the plurality of photon directing devices configured to receive light from an input and direct the light according to a trained machine learning model, each photon directing device of the plurality of photon directing devices corresponding to a layer of the trained machine learning model;
a plurality of lenses provided for each photon directing device of the plurality of photon directing device, the plurality of lenses of a respective photon directing device being formed based on weights of a layer of the trained machine learning model corresponding to the respective photon directing device; and
a plurality of optical sensors to receive the light directed by the plurality of photon directing devices, each of the plurality of optical sensors corresponding to an inference of the trained machine learning model.

2. The optical device of claim 1, wherein each lens of the plurality of lenses comprises a focal power defined by the weights.

3. The optical device of claim 1, wherein each photon directing device is provided as a sheet of material, and wherein the plurality of lenses comprises deformations within the material of the respective photon directing device.

4. The optical device of claim 3, wherein the deformations are defined by the weights of the layer of the trained machine learning model corresponding to the respective photon directing device.

5. The optical device of claim 1, wherein each lens of the plurality of lenses comprises an optical axis, wherein one or more of the optical axes are tilted with respect to the common optical axis based on the weights.

6. The optical device of claim 1, wherein each lens of the plurality of lenses corresponds to a neuron of a corresponding layer of the trained machine learning model and formed to mimic connections between the neuron of the corresponding layer and one or more neurons of an adjacent layer of the trained machine learning model.

7. The optical device of claim 1, wherein the plurality of optical sensors are configured to detect an intensity of light from the plurality of photon directing devices and activate the neural network to label the input based on detected intensity.

8. The optical device of claim 1, wherein the plurality of photon directing devices corresponds to a plurality of machine learning models based on a plurality of polarizations of light.

9. The optical device of claim 1, wherein the plurality of photon directing devices corresponds to a plurality of machine learning model based on a plurality of electromagnetic wavelengths.

10. An authentication system, comprising:
an optical inference engine encoded with a biometric, the optical inference engine comprising:
a plurality of photon directing devices configured to receive light from an input biometric and direct the light according to a machine learning model trained to authenticate the input biometric based on the encoded biometric, each photon directing device of the plurality of photon directing devices corresponding to a layer of the machine learning model, and
a plurality of lenses provided for each photon directing device of the plurality of photon directing device, the plurality of lenses of a respective photon directing device being formed based on weights of a layer of the machine learning model corresponding to the respective photon directing device;
an identification device comprising the optical inference engine; and
at least one optical sensor configured to receive an output from the optical inference engine according to the machine learning model and output an authentication result.

11. The authentication system of claim 10, wherein each lens of the plurality of lenses comprises a focal power defined by the weights.

12. The authentication system of claim 10, wherein each lens of the plurality of lenses comprises an optical axis, wherein one or more of the optical axes are tilted with respect to a common optical axis based on the weights, the plurality of photon directing devices arranged on the common optical axis.

13. The authentication system of claim 10, wherein each photon directing device is provided as a sheet of material comprising deformations within the material corresponding to lenses.

14. The authentication system of claim 10, wherein the at least one optical sensor is configured to detect an intensity of light output from the optical inference engine and authenticate the input biometric based on the detected intensity.

15. The authentication system of claim 10, wherein the input biometric is provided by a biometric scanner configured to scan a live biometric of user.

16. The authentication system of claim 10, wherein the encoded biometric is one of a fingerprint, a signature, a face, a genome, and an iris.

17. A method for activating a deep neural network, comprising:
training deep neural network by applying numerical training data to a machine learning algorithm, the deep neural network comprising a plurality of hidden layers having connections between adjacent hidden layers, wherein training the deep training deep neural network comprises learning weights for the connections;
storing the learned weights in a data structure;
forming a plurality of photon directing devices corresponding to the plurality of hidden layers, wherein each photon directing device comprises a plurality of lenses that are shaped based on the learned weights; and
activating the deep neural network based on inputting an optical signal into the plurality of photon directing device.

18. The method of claim 17, further comprising:
defining a focal power for each lens of the plurality of lenses based on the weights.

19. The method of claim 17, wherein each lens of the plurality of lenses corresponds to a neuron of a corresponding layer of the trained machine learning model and formed to mimic connections between the neuron of the corresponding layer and one or more neurons of an adjacent layer of the trained machine learning model.

20. The method of claim 17, further comprising:
detecting, by at least one optical sensor, an intensity of light output by the plurality of photon directing devices,
wherein activating the deep neural network comprises labelling the input optical signal based on the detected intensity.
